(19) United States
(12) Patent Application Publication
(10) Pub. No.: US 2016/0004302 A1
(43) Pub. Date: Jan. 7, 2016

(54) Eye Contact During Video Conferencing

(71) Applicant: Alcatel-Lucent USA Inc., Murray Hill, NJ (US)

(72) Inventor: Cristian A. Bolle, Bridgewater, NJ (US)

(21) Appl. No.: 14/324,361

(22) Filed: Jul. 7, 2014

(51) Int. Cl. G06F 3/01; H04N 13/02; H04N 5/33; H04N 7/15

(52) U.S. Cl. CPC G06F 3/013; H04N 7/15; H04N 13/0203; H04N 5/33

(57) ABSTRACT

In one embodiment, a video-conferencing terminal has a monitor; a non-visible-light (e.g., IR) camera configured to generate an eye-contact non-visible-light (e.g., IR) image of a video-conference participant; one or more visible-light cameras, each configured to generate a non-eye-contact visible-light image of the participant; and a mirror positioned in front of the monitor and configured to (i) transmit visible light from the monitor towards the participant and (ii) reflect non-visible light from the participant towards the non-visible-light camera. The terminal (1) generates an eye-contact visible-light image from the eye-contact non-visible-light image and the one or more non-eye-contact visible-light images and (2) transmits the eye-contact visible-light image to a remotely located video-conferencing terminal. The eye-contact visible-light image is generated using pattern matching and color mapping processing that may be less complex than the stereoscopic analysis and image rotation processing of the prior art.

### BACKGROUND

1. Field of the Invention

The present invention relates to telecommunications and, more specifically but not exclusively, to image processing for video conferencing.

2. Description of the Related Art

This section introduces aspects that may help facilitate a better understanding of the invention. Accordingly, the statements of this section are to be read in this light and are not to be understood as admissions about what is prior art or what is not prior art.

In a typical video-conferencing terminal, such as a laptop computer, the digital video camera (aka “camera” for short) is located at the top of the monitor. As such, if, instead of looking directly into the camera, a local, first video-conference participant looks at the displayed image of a remotely located second participant, then, in the display presented on the second participant's remotely located monitor, the first participant will appear to be looking down, instead of looking directly into the eye of the second participant, and vice versa.

One way to avoid this effect is to use a teleprompter configuration in which (i) a two-way mirror is positioned between the local participant and a camera and oriented at an angle (e.g., 45 degrees) with respect to the line of sight from the camera to the local participant and (ii) the computer display is projected onto the two-way mirror such that (i) light reflected from the participant's face passes through the two-way mirror to the camera and (ii) the projected computer display is reflected from the two-way mirror towards the participant. If the camera is positioned correctly and the mirror is oriented properly, then the local participant in the camera image transmitted to and displayed at a remotely located video-conferencing terminal will appear to be making direct eye-contact with the remotely located participant. Unfortunately, since two-way mirrors reflect and transmit only portions of their incident light, the displayed images are not always sufficiently bright. Furthermore, angling the two-way mirrors results in a bulky configuration.

Ott et al., “Teleconferencing Eye Contact Using a Virtual Camera,” Proceeding of CHI '93 INTERACT '93 and CHI '93 Conference Companion on Human Factors in Computing Systems, pages 109-110, ACM New York, N.Y., USA, 1993, describe another technique for generating an image for display during video conferencing in which each participant appears to be looking directly into the eye of the other participant. According to this technique, stereoscopic analysis is performed on two camera views generated using cameras positioned on either side of the monitor to generate a partial three-dimensional description of the scene. Using this information, one of the camera views is rotated to generate a centered coaxial view that preserves eye contact. Unfortunately, the processing involved in this technique is computationally intensive and relatively complicated and/or the resulting image are often of relatively low quality. In some situations, not all of the image that preserves eye contact can be generated.

### SUMMARY

In one embodiment, a video-conferencing terminal comprises a monitor; a non-visible-light camera configured to generate an eye-contact non-visible-light image of a video-conference participant; one or more visible-light cameras, each configured to generate a non-eye-contact visible-light image of the participant; and a mirror positioned in front of the monitor. The mirror is configured to (i) transmit visible light from the monitor towards the participant and (ii) reflect non-visible light from the participant towards the non-visible-light camera. The terminal is configured to (1) generate an eye-contact visible-light image from the eye-contact non-visible-light image and the one or more non-eye-contact visible-light images and (2) transmit the eye-contact visible-light image to a remotely located video-conferencing terminal.

In another embodiment, the method generates an eye-contact visible-light image of a video-conference participant using a video-conferencing terminal. The method comprises (a) generating one or more non-eye-contact visible-light images of the participant; (b) transmitting visible light from the monitor towards the participant; (c) reflecting non-visible light from the participant; (d) generating an eye-contact non-visible-light image of the participant from the reflected non-visible light; (e) generating an eye-contact visible-light image from the eye-contact non-visible-light image and the one or more non-eye-contact visible-light images; and (f) transmitting the eye-contact visible-light image to a remotely located video-conferencing terminal.

### BRIEF DESCRIPTION OF THE DRAWINGS

Other embodiments of the invention will become more fully apparent from the following detailed description, the appended claims, and the accompanying drawings in which like reference numerals identify similar or identical elements.

FIG. 1 shows a simplified representation of an exemplary video-conferencing terminal, such as a laptop computer or tablet, that can be used to generate images for video conferences in which the video-conference participants appear to be looking directly into the eyes of each other;

FIG. 2 represents the image-data processing performed by the video-conferencing terminal of FIG. 1 when configured with four regular cameras located at the upper and lower, right and left corners of the monitor;

FIG. 3 shows a simplified flow diagram of the processing implemented within the video-conferencing terminal of FIG. 1 to generate the computer-generated, eye-contact, visible-light image of FIG. 2; and

FIG. 4 represents the image-data processing performed by the video-conferencing terminal of FIG. 1 when one or more of the regular cameras are replaced with cameras that generate both visible-light images and IR-light images.

### DETAILED DESCRIPTION

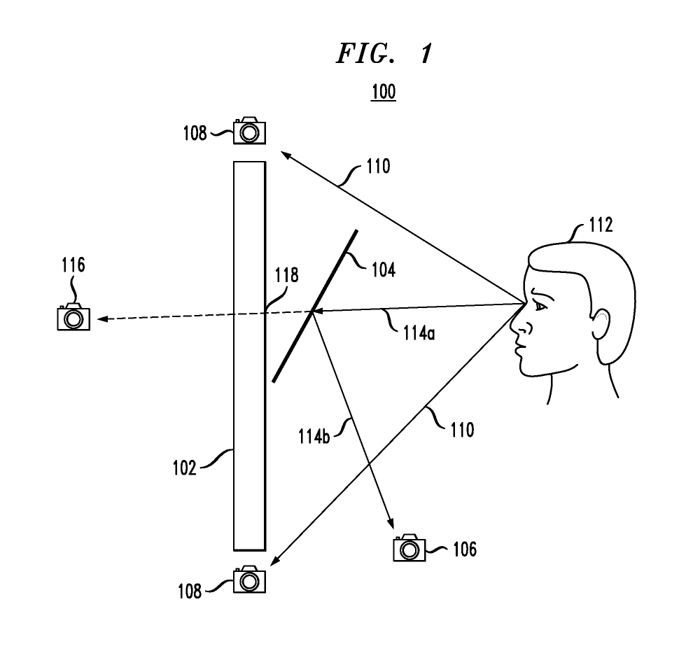

FIG. 1 shows a simplified representation of an exemplary video-conferencing terminal 100, such as a laptop computer or tablet, that can be used to generate images for video conferences in which the video-conference participants appear to be looking directly into the eyes of each other. Terminal 100 includes a conventional computer monitor 102, a non-visible-light mirror 104, a non-visible-light camera 106, and two or more conventional, visible-light cameras 108 positioned around the periphery of the monitor, only two of which visible-light cameras are represented in FIG. 1. Although not shown in FIG. 1, terminal 100 also has all of the conventional components of a computer-based video-conferencing terminal, including (i) processing components capable of processing the image data generated by the various cameras and (ii) transceiver components for transmitting and receiving video-conferencing data.

As used in this specification, the term “visible-light camera” (also referred to herein as a “regular camera”) refers to a conventional camera that generates images based on light that is visible to humans, while the term “non-visible-light camera” refers to a camera that generates images based on light that is not visible to humans. For example, an infrared (IR) camera is a particular type of non-visible-light camera that generates images based on IR light that is not visible to humans, while an ultraviolet (UV) camera is a different type of non-visible-light camera that generates images based on UV light that is also not visible to humans.

As used in this specification, the term “non-visible-light mirror” refers to a special type of mirror that transmits (i.e., is transparent to) (most if not all) visible light and reflects (most if not all) non-visible-light that falls within a specific, suitable frequency range. As used in this specification and as known in the art, the term “hot mirror” (aka IR mirror) refers to a special type of non-visible-light mirror that transmits (most if not all) visible light and reflects (most if not all) non-visible IR light. As used in this specification, the term “UV mirror” refers to a special type of non-visible-light mirror that transmits (most if not all) visible light and reflects (most if not all) non-visible UV light.

For ease of discussion, video-conferencing terminal 100 will be described in the context of exemplary implementations in which non-visible-light mirror 104 is a hot or IR mirror, and non-visible-light camera 106 is an IR camera capable of generating images based on the IR light reflected from IR mirror 104. Note that, in some implementations, the IR light is near-infrared light because some conventional, regular cameras have enough sensitivity in the near IR to function as IR camera 106. Those skilled in the art will understand how to implement video-conferencing terminal 100 using other suitable types of non-visible-light mirrors and non-visible-light cameras, such as UV mirrors and cameras.

As represented in FIG. 1, ambient visible light 110 reflected off the face of local video-conference participant 112 is captured by each of the various regular cameras 108 to generate different visible-light images of participant 112 from the different vantage points of those regular cameras. At the same time, incident IR light 114a from the face of participant 112 is reflected by IR mirror 104 as reflected IR light 114b towards IR camera 106, which may be located, for example, at the base of the monitor and which generates an IR-light image of participant 112 from a vantage point as if the IR camera were positioned at virtual location 116. Note that, due to the reflection of IR light from IR mirror 104, the IR-light image generated by IR camera 106 is the left-to-right “mirror image” of the IR-light image that would be generated by an IR camera located at virtual location 116, which can be easily corrected by digitally flipping the acquired image. Note further that visible light emitted from monitor 102 passes relatively unimpeded through IR mirror 104 towards participant 112. Note further that an IR-light source (not shown) may be used to illuminate participant 112 with non-visible IR light to improve the quality of the IR-light image generated by IR camera 106.

In a preferred configuration, IR mirror 104 and IR camera 106 are appropriately positioned and oriented such that, when monitor 102 displays an image of the other, remotely located video-conference participant (not shown in FIG. 1), the location on the monitor of the other participant's displayed eyes substantially coincides with the monitor location 118 that is located along the line that joins the eyes of participant 112 and the virtual location 116 of IR camera 106.

The image data of participant 112 that is transmitted from terminal 100 to the remotely located terminal (not shown in FIG. 1) of the other participant is generated by mapping the IR-image data generated by IR camera 106 into computer-generated image data in the visible domain based on the actual visible-image data generated by the multiple regular cameras 108. This image-data processing is described further below.

With such a configuration of terminal 100 and such image-data processing, the image of participant 112 presented on the other participant's remotely located monitor (not shown in FIG. 1) will appear to be looking directly into the eyes of the other participant. Similarly, if the other participant has a video-conferencing terminal like terminal 100, the image of the other participant presented to participant 112 on monitor 102 will appear to be looking directly into the eyes of participant 112.

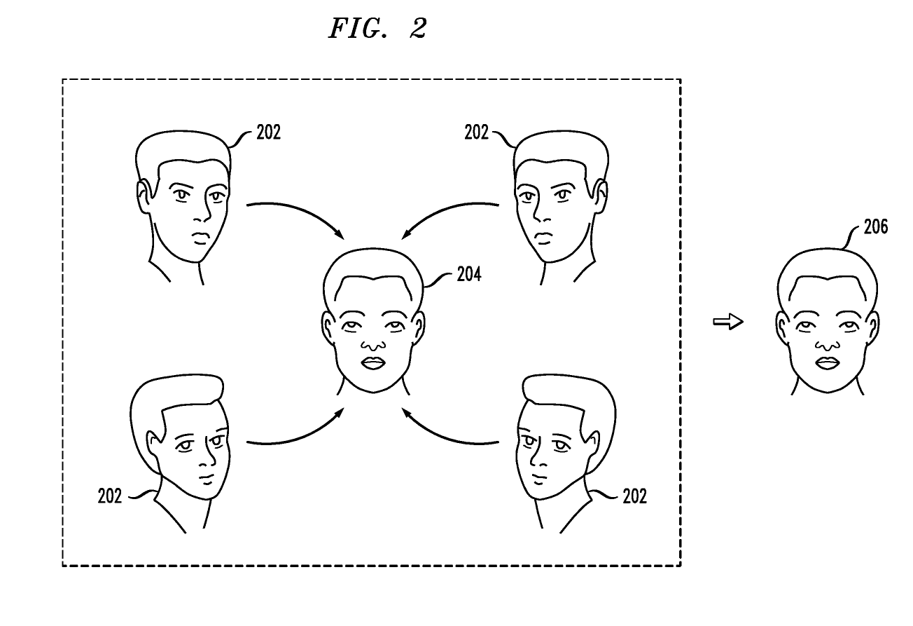

FIG. 2 represents the image-data processing performed by video-conferencing terminal 100 of FIG. 1 when configured with four regular cameras 108 located at the upper and lower, right and left corners of monitor 102. Those four regular cameras generate four visible-light images 202 of local video-conference participant 112 from their four different “non-eye-contact” vantage points, while IR camera 106 generates IR-light image 204 from its virtual “eye-contact” vantage point 116. Note that, although FIG. 2 shows a representation of IR-light image 204, in reality, humans cannot see that image. Note further that the IR-light image 204 has already been inverted left-to-right to take into account the mirror-image reflection of the IR light from IR mirror 104.

As represented in FIG. 2, data from the four visible-light images 202 is used to map the IR-image data of IR-light image 204 into visible-image data of a computer-generated, visible-light image 206 that humans can see and which data is transmitted to the remotely located video-conferencing terminal for display to the other video-conference participant. Note that, at some point, the image-data processing will have to take into account the left-to-right inversion resulting from the “mirror-image” reflection of IR light 114 from IR mirror 104. Note further that, unlike the four “non-eye-contact” visible-light images 202, computer-generated visible-light image 206 is an “eye-contact” image of participant 112 that is the visible-light analogue of “eye-contact” IR-light image 204.

There are a variety of different techniques for generating computer-generated visible-light image 206 from the image data of images 202 and 204. According to one technique, suitable pattern-matching algorithms are applied to identify regions within IR-light image 204 that correspond to specific regions within visible-light images 202. Various pattern-matching algorithms are described by D. Scharstein and R. Szeliski, “A Taxonomy and Evaluation of Dense Two-Frame Stereo Correspondence Algorithms,” International Journal of Computer Vision, Volume 47, Issue 1-3, pp. 7-42 (2002), the teachings of which are incorporated herein by reference. The data for each identified region within IR-light image 204 is then replaced with data representative of the color of the corresponding pattern-matched region within the visible-light images 202. Subsequent image processing can be performed to smooth the transitions between adjacent regions to reduce blockiness and thereby improve the quality of the resulting computer-generated visible-light image 206. Depending on the situation, more than four regular cameras can be deployed around the monitor to improve the quality of the resulting computer-generated visible-light image 206. If quality is satisfactory, then fewer than four regular cameras can also be used.

In an alternative implementation, after pattern matching has been performed to identify corresponding regions, pattern tracking can then be performed to track the region locations in subsequent visible and IR images. Depending on the embodiment, pattern tracking can be less computationally intense than pattern matching from scratch each time.

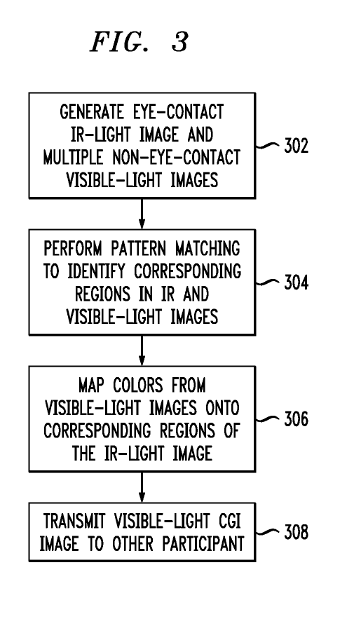

FIG. 3 shows a simplified flow diagram of the processing implemented within terminal 100 of FIG. 1 to generate computer-generated, eye-contact, visible-light image 206 of FIG. 2. In step 302, IR camera 106 generates IR-light image 204, and regular cameras 108 generate visible-light images 202. In step 304, a processor (not shown) in terminal 100 performs pattern matching to identify corresponding regions in the IR- and visible-light images. In step 306, the processor maps colors from the visible-light images onto corresponding regions of the IR-light image. In step 308, terminal 100 transmits the resulting visible-light image 206 to the remotely located video-conferencing terminal of the other participant.

In alternative implementations of terminal 100, one or more or even all of the regular cameras 108 are replaced by cameras that are capable of generating both visible-light images and IR-light images. In that case, the image-data processing involved in pattern matching between images could be simplified compared to that of the previous implementation, in which pattern matching is performed between an IR-light image generated from a first, “eye-contact” vantage point and one or more visible-light images generated from various “non-eye-contact” vantage points different from the first vantage point. In one possible alternative implementation, the pattern matching would be performed between different IR-light images, albeit from different vantage points, which pattern matching might be able to be performed more simply than pattern matching between images of different types of light and from different vantage points.

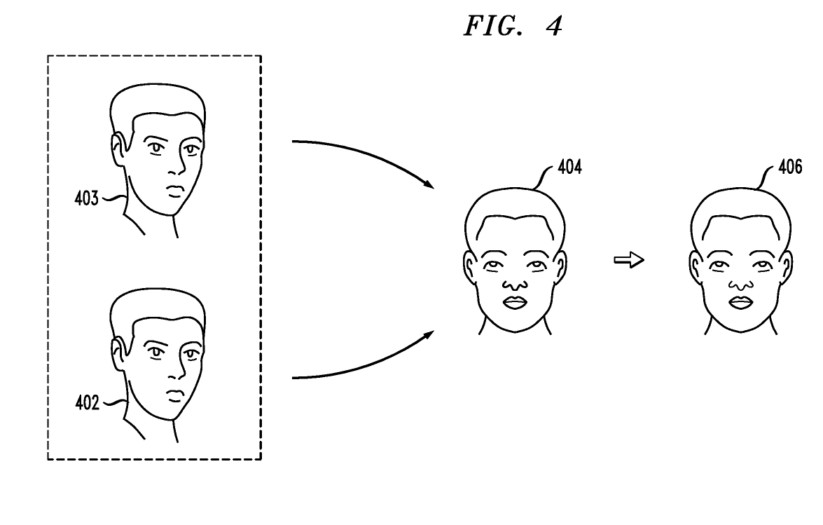

FIG. 4 represents the image-data processing performed by video-conferencing terminal 100 of FIG. 1 when one or more of regular cameras 108 are replaced with cameras that generate both visible-light images and IR-light images. FIG. 4 shows the image data generated by only one of those replacement cameras. In particular, the replacement camera generates both a visible-light image 402 and an IR-light image 403 from the same non-eye-contact vantage point, while IR camera 106 still generates eye-contact IR-light image 404 from its virtual vantage point 116 behind monitor 102.

In this case, according to one implementation, pattern matching is performed between IR-light images 403 and 404 to identify regions in non-eye-contact IR-light image 403 that correspond to regions in eye-contact IR-light image 404. Note that each identified region of non-eye-contact IR-light image 403 corresponds to a region of non-eye-contact visible-light image 402. Color mapping is then performed to replace the monochromatic IR-image data of each region in eye-contact IR-light image 404 with data representing the color of the corresponding region of non-eye-contact visible-light image 402 to generate computer-generated, eye-contact, visible-light image 406 Here, too, subsequent image-data processing can be performed to reduce blockiness and improve quality of the resulting visible-light image 406.

Note that the computations involved in the pattern matching and color mapping of the present disclosure can be simpler than the computation required by the stereoscopic analysis and image rotation of Ott et al.

Embodiments of the invention can be manifest in the form of methods and apparatuses for practicing those methods. Embodiments of the invention can also be manifest in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the invention. Embodiments of the invention can also be manifest in the form of program code, for example, stored in a non-transitory machine-readable storage medium including being loaded into and/or executed by a machine, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits

Any suitable processor-usable/readable or computer-usable/readable storage medium may be utilized. The storage medium may be (without limitation) an electronic, magnetic, optical, electromagnetic, infrared, or semiconductor system, apparatus, or device. A more-specific, non-exhaustive list of possible storage media include a magnetic tape, a portable computer diskette, a hard disk, a random access memory (RAM), a read-only memory (ROM), an erasable programmable read-only memory (EPROM) or Flash memory, a portable compact disc read-only memory (CD-ROM), an optical storage device, and a magnetic storage device. Note that the storage medium could even be paper or another suitable medium upon which the program is printed, since the program can be electronically captured via, for instance, optical scanning of the printing, then compiled, interpreted, or otherwise processed in a suitable manner including but not limited to optical character recognition, if necessary, and then stored in a processor or computer memory. In the context of this disclosure, a suitable storage medium may be any medium that can contain or store a program for use by or in connection with an instruction execution system, apparatus, or device.

The functions of the various elements, including any functional blocks described as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A video-conferencing terminal comprising:
a monitor;
a non-visible-light camera configured to generate an eye-contact non-visible-light image of a video-conference participant;
one or more visible-light cameras, each configured to generate a non-eye-contact visible-light image of the participant; and
a mirror positioned in front of the monitor and configured to (i) transmit visible light from the monitor towards the participant and (ii) reflect non-visible light from the participant towards the non-visible-light camera, wherein the terminal is configured to (1) generate an eye-contact visible-light image from the eye-contact non-visible-light image and the one or more non-eye-contact visible-light images and (2) transmit the eye-contact visible-light image to a remotely located video-conferencing terminal.

2. The terminal of claim 1, wherein:
the non-visible-light camera is an infrared (IR) camera configured to generate an eye-contact IR-light image; and
the mirror is a hot mirror.

3. The terminal of claim 1, wherein the terminal is configured to generate the eye-contact visible-light image by:
(a) performing pattern matching to identify regions in the one or more non-eye-contact visible-light images corresponding to regions in the eye-contact non-visible-light image; and
(b) performing color mapping to replace data in the regions of the eye-contact non-visible-light image with data representing colors of the identified regions in the one or more non-eye-contact visible-light image to generate the eye-contact visible-light image.

4. The terminal of claim 3, wherein the pattern matching is performed between the one or more non-eye-contact visible-light images and the eye-contact non-visible-light image.

5. The terminal of claim 3, wherein:
at least one visible-light camera is further configured to generate a non-eye-contact non-visible-light image; and
at least some of the pattern matching is performed between the non-eye-contact non-visible-light image and the eye-contact non-visible-light image.

6. The terminal of claim 1, wherein:
the non-visible-light camera is an infrared (IR) camera configured to generate an eye-contact IR-light image;
the mirror is a hot mirror; and
the terminal is configured to generate the eye-contact visible-light image by:
(a) performing pattern matching to identify regions in the one or more non-eye-contact visible-light images corresponding to regions in the eye-contact non-visible-light image; and
(b) performing color mapping to replace data in the regions of the eye-contact non-visible-light image with data representing colors of the identified regions in the one or more non-eye-contact visible-light image to generate the eye-contact visible-light image.

7. The terminal of claim 6, wherein the pattern matching is performed between the one or more non-eye-contact visible-light images and the eye-contact non-visible-light image.

8. The terminal of claim 6, wherein:
at least one visible-light camera is further configured to generate a non-eye-contact non-visible-light image; and
at least some of the pattern matching is performed between the non-eye-contact non-visible-light image and the eye-contact non-visible-light image.

9. A method for generating an eye-contact visible-light image of a video-conference participant using a video-conferencing terminal, the method comprising:
(a) generating one or more non-eye-contact visible-light images of the participant;
(b) transmitting visible light from the monitor towards the participant;
(c) reflecting non-visible light from the participant;
(d) generating an eye-contact non-visible-light image of the participant from the reflected non-visible light;
(e) generating an eye-contact visible-light image from the eye-contact non-visible-light image and the one or more non-eye-contact visible-light images; and
(f) transmitting the eye-contact visible-light image to a remotely located video-conferencing terminal.

10. The method of claim 9, wherein:
one or more visible-light cameras located around a periphery of a monitor of the terminal generate the one or more non-eye-contact visible-light images of the participant;
a mirror (i) transmits the visible light from the monitor towards the participant and (ii) reflects the non-visible light from the participant;
a non-visible-light camera generates the eye-contact non-visible-light image of the participant from the reflected non-visible light; and
the terminal (i) generates the eye-contact visible-light image from the eye-contact non-visible-light image and the one or more non-eye-contact visible-light images and (ii) transmits the eye-contact visible-light image to the remotely located video-conferencing terminal.

11. The method of claim 10, wherein:
the non-visible-light camera is an infrared (IR) camera that generates an eye-contact IR-light image; and
the mirror is a hot mirror.

12. The method of claim 10, wherein the terminal generates the eye-contact visible-light image by:
(a) performing pattern matching to identify regions in the one or more non-eye-contact visible-light images corresponding to regions in the eye-contact non-visible-light image; and
(b) performing color mapping to replace data in the regions of the eye-contact non-visible-light image with data representing colors of the identified regions in the one or more non-eye-contact visible-light image to generate the eye-contact visible-light image.

13. The method of claim 12, wherein the pattern matching is performed between the one or more non-eye-contact visible-light images and the eye-contact non-visible-light image.

14. The method of claim 12, wherein:
at least one visible-light camera generates a non-eye-contact non-visible-light image; and
at least some of the pattern matching is performed between the non-eye-contact non-visible-light image and the eye-contact non-visible-light image.

15. The method of claim 9, wherein:
one or more visible-light cameras located around a periphery of a monitor of the terminal generate the one or more non-eye-contact visible-light images of the participant;
a mirror (i) transmits the visible light from the monitor towards the participant and (ii) reflects the non-visible light from the participant;
a non-visible-light camera generates the eye-contact non-visible-light image of the participant from the reflected non-visible light;
the terminal (i) generates the eye-contact visible-light image from the eye-contact non-visible-light image and the one or more non-eye-contact visible-light images and (ii) transmits the eye-contact visible-light image to the remotely located video-conferencing terminal;
the non-visible-light camera is an infrared (IR) camera that generates an eye-contact IR-light image;
the mirror is a hot mirror; and
the terminal generates the eye-contact visible-light image by:
(a) performing pattern matching to identify regions in the one or more non-eye-contact visible-light images corresponding to regions in the eye-contact non-visible-light image; and
(b) performing color mapping to replace data in the regions of the eye-contact non-visible-light image with data representing colors of the identified regions in the one or more non-eye-contact visible-light image to generate the eye-contact visible-light image.

16. The method of claim 15, wherein the pattern matching is performed between the one or more non-eye-contact visible-light images and the eye-contact non-visible-light image.

17. The method of claim 15, wherein:
at least one visible-light camera generates a non-eye-contact non-visible-light image; and
at least some of the pattern matching is performed between the non-eye-contact non-visible-light image and the eye-contact non-visible-light image.
